(19) United States
(12) Patent Application Publication
(10) Pub. No.: US 2012/0066607 A1
(43) Pub. Date: Mar. 15, 2012

(54) Sharing and Management of Transferable Virtual Desktop

(75) Inventors: Young G. Song, Palo Alto, CA (US); Richard Sah, San Mateo, CA (US); Frank C. Pesek, Emeryville, CA (US)

(73) Assignee: ZERODESKTOP, INC., San Francisco, CA (US)

(21) Appl. No.: 13/070,390

(22) Filed: Mar. 23, 2011

Related U.S. Application Data
(63) Continuation-in-part of application No. 12/881,079, filed on Sep. 13, 2010.

(51) Int. Cl. G06F 3/048; G06F 15/16

(52) U.S. Cl. 715/737

(57) ABSTRACT

Each of a plurality of user is given access to replicated version of a virtual computer. The replicated virtual computers are generated by copying a computer profile of an original virtual computer and associated files of the original virtual computer. Each of the users accesses, manipulates and performs operation on the assigned virtual computer as desired without affecting the operations on other users' virtual computers. After a user finishes using the replicated virtual computer, the replicated virtual computer may be deleted from the remote server or stored as the user's virtual computer. The user can store multiple versions of virtual computers, some of which are based on replicated virtual computers.

### CROSS REFERENCE TO RELATED APPLICATIONS

This application is a continuation-in-part application of U.S. patent application Ser. No. 12/881,079, filed on Sep. 13, 2010, and titled “Disposable Virtual Desktop for Transient Use by Multiple Users,” which is incorporated by reference herein in its entirety. This application is related to U.S. patent application Ser. No. 12/892,259, filed on Sep. 29, 2010, and titled “Virtual Desktop Service with Targeted Advertisement”; and U.S. patent application Ser. No. 12/887,398, filed on Sep. 21, 2010, and titled “On-Premise Deployment of Virtual Desktop Service Servers.”

### BACKGROUND OF THE INVENTION

1. Field of the Invention

This invention relates generally to desktop virtualization, and more specifically to temporary virtual desktops that are transferable to a plurality of users.

2. Description of the Related Art

Desktop virtualization involves storing a logical representation of a personal desktop computer (hereinafter referred to as “desktop”) on a remote server and implementing the functionality of the desktop on the remote server. In many cases, the remote server implements multiple versions of virtual desktops, where each version of the virtual desktop is individualized for a single user who accesses the remote server via a network. Although specific tasks assigned to the remote server and the user terminals differ based on implementations, the remote server often performs most of the heavy processing tasks while the user terminals often performs relatively light processing tasks such as generating graphical user interfaces and tracking user input activities. By leveraging the resources of the remote server, even a thin client device with limited capabilities can perform operations that require high-performance computing devices.

The desktop virtualization has, among others, the following advantages: First, updating and maintaining operations (e.g., installation of updated software) are less time-consuming because these operations can be performed centrally at the remote server. Second, the recovery operation associated with failed desktops can be performed efficiently because a flawed virtual desktop can be deleted and replaced with a new version of virtual desktop in a relatively small amount of time. Third, the operation of the desktop can be monitored and managed centrally, reducing security risks. The virtual desktop can be shutdown or restarted from a central location in case of a security event. Fourth, the overall cost for purchasing or renting devices can be lowered because low performance user terminals can be deployed even for applications that require high-performance computing devices.

Generally, conventional virtual desktop infrastructure (VDI) creates, stores and loads full images of software components (including an operating system) for each virtualized desktop. To instantiate and execute multiple virtual desktops, the conventional schemes often employ a hypervisor to share hardware resources of the remote server across the multiple instances of virtual desktops. However, managing multiple images of desktops and operating the hypervisor consume a large amount of storage and processing resources at the remote server. Further, each image of the software components may include duplicative components that occupy memory space within the remote server. Hence, conventional desktop virtualization schemes have limited scalability and suffer from inefficient use of resources.

Moreover, conventional desktop virtualization schemes adopt proprietary communication protocols to transmit data between the remote server and the user terminals. These communication protocols typically transmit low-level pixel data to the user terminal to display a graphical user interface on the screen of the user terminal. Transmission of such low-level pixel data often requires significant communication bandwidth and also renders the processes associated with the desktop virtualization inefficient.

### SUMMARY OF THE INVENTION

Embodiments relate to providing a plurality of virtualized computers on a computing device to allow multiple users to access and perform operations. The virtual computers are replicated from an original virtual computer created by a creator and have an initial configuration that is the same as the original virtual computer. When a user requests access, a replicated virtual computer is created for the user on the computing device by replicating an original virtual computer. After performing the operations, the user can remove the replicated virtual computer from the computing device or store the replicated virtual computer for later access.

In one embodiment, an address for accessing the replicated virtual computer is transmitted to the user. The address may be in the form of a URL (Universal Resource Locator).

In one embodiment, replicated virtual computers are created by copying the computer profile of the original virtual computer and associated files of the computer profile of the original virtual computer, and loading the copied computer profiles in the computing device.

In one embodiment, the computing device sends data for presenting the replicated virtual computers to user terminals of the users via HTTP or its variant protocol. HTTP or its variant protocols enable efficient transmission of graphic user interface elements for display on the user terminals.

In one embodiment, the computing device sends the data comprising JSON (JavaScript Object Notation) objects to user terminals to present the graphical user interface elements on the user terminals.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram illustrating the architecture of a desktop virtualization system, according to one embodiment.

FIG. 2 is a schematic block diagram of a remote server cluster, according to one embodiment.

FIG. 3 is a block diagram of a service server, according to one embodiment.

FIG. 4 is a block diagram illustrating components of a virtual desktop application, according to one embodiment.

FIG. 5 is a block diagram illustrating components of a user terminal, according to one embodiment.

FIG. 6 is a flowchart illustrating a method of creating, storing and sending a transferable virtual desktop, according to one embodiment.

FIG. 7 is a flowchart illustrating a method of accessing and operating a transferable desktop instance, according to one embodiment.

FIG. 8 is a graphical representation of a transferable desktop instance, according to one embodiment.

FIG. 9 is a graphical representation of a user interface for sending address of a transferable desktop instance, according to one embodiment.

FIG. 10 is a graphical representation of a user interface for selecting a stored user desktop profile, according to one embodiment.

FIG. 11 is a graphical representation of a user interface for linking a user's account to a transferable desktop instance, according to one embodiment.

### DETAILED DESCRIPTION OF THE EMBODIMENTS

Reference in the specification to “one embodiment,” “an embodiment” or “the embodiment’ means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, a personal digital assistant (PDA), a cellular telephone or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, flash memory or drives, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Embodiments relate to giving access to replicated versions of an original virtual computer to a plurality of users. The replicated virtual computers are generated by copying a computer profile of an original virtual computer and associated files of the original virtual computer. Each of the users accesses, manipulates and performs operation on the assigned virtual computer as desired without affecting the operations on other users' virtual computers. After a user finishes using the replicated virtual computer, the replicated virtual computer may be deleted from the remote server or stored as the user's virtual computer. The user can store multiple versions of virtual computers, some of which are based on replicated virtual computers.

A user described herein may be a transient user or an account holder. The transient user is a user that does not have an account in a service for providing the virtual computers. An account holder is a user registered in the service for providing the virtual computers. The account holder may be a paid account holder or a non-paid account holder.

A computer profile described herein refers to information about properties and characteristics of a computer that is virtualized on a physical computer. The computer profile may include, for example, a desktop configuration and user preferences. The desktop configuration include configuration of a desktop screen presented to a user after login and may specify the locations of graphical user elements (e.g., icons) on a screen, background images on the desktop screen, and association of certain types of files and application programs. The user preferences may include, among others, default font size of characters on the screen, themes of the desktop screen, display options in file navigation programs, and settings for input systems.

A virtual computer herein refers to a logical representation of computer that is embodied on a physical computing device. A single physical computing device may instantiate a plurality of virtual computers. From the perspective of the users, each virtual computer functions and operates as if the virtual computer is a separate physical computing device.

### Architecture of Desktop Virtualization System

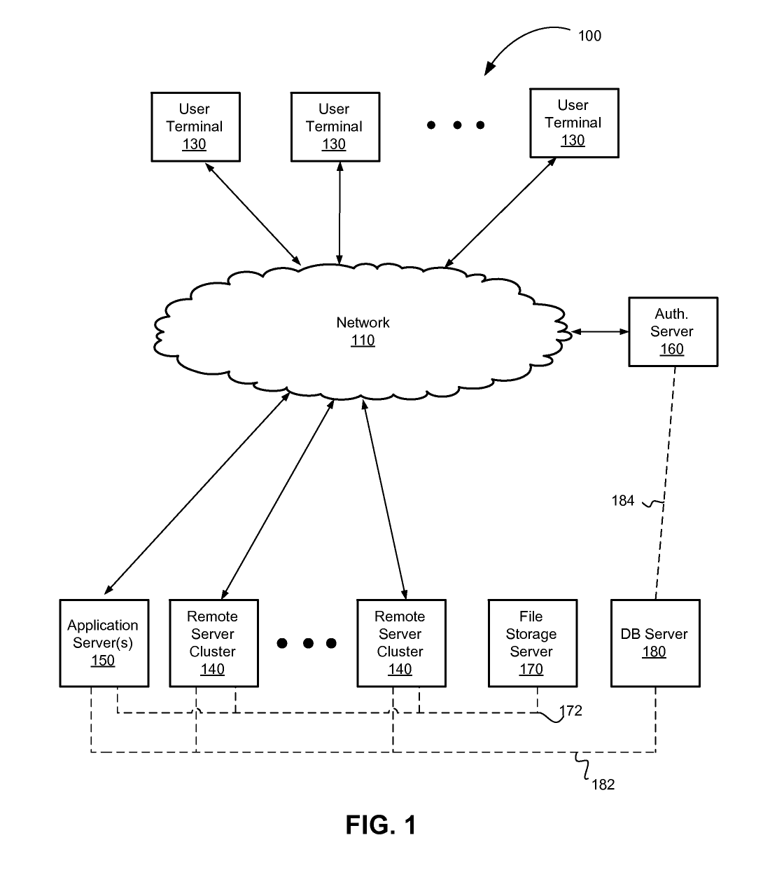

FIG. 1 is a diagram illustrating the architecture of a desktop virtualization system 100, according to one embodiment. The desktop virtualization system 100 may include, among other components, a network 110, user terminals 130, remote server clusters 140, one or more application servers 150, an authentication server 160, a file storage server 170, and a database server 180. The desktop virtualization system 100 may include components not illustrated in FIG. 1. Further, two or more components illustrated in FIG. 1 may be combined into a single component. For example, in a simplified version of the architecture, the application servers 150, the authentication server 160, the file storage server 170, and the database server 180 may be combined into a single server.

The network 110 allows communication of data between various components of the desktop virtualization server 160. The network 100 may include multiple processing systems and in one embodiment is a network controller. The network of processing systems may comprise a local area network (LAN), a wide area network (WAN) (e.g., the Internet), and/or any other interconnected data paths across which multiple devices may communicate. The network 100 may use standard network protocols such as TCP/IP, HTTP, HTTPS, and SMTP as well as customized network protocols.

The user terminals 130 are computing devices that allow users to access virtual desktops executed and running on the remote server clusters 140. Each of the user terminals 130 includes components for generating and displaying a graphical user interface elements to interact with the user and a networking component to exchange data with other components of the desktop virtualization system 100, as described below in detail with reference to FIG. 5. The user terminals 130 may include, but are not limited to, desktop computers, laptop computers, tablet computers, personal digital assistants (PDAs), cell phones, smartphones, game consoles, set-top boxes, and televisions or other appliances with networking capabilities.

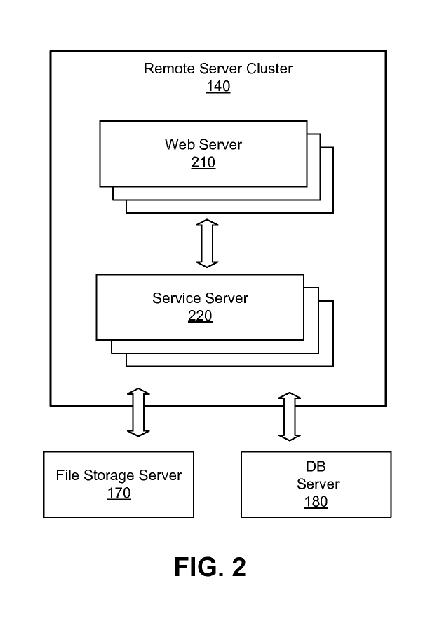

The remote server clusters 140 include one or more servers for providing virtual desktop services to the users. Although multiple remote server clusters 140 are illustrated in FIG. 1, only a single server or a single server cluster may be provided in the desktop virtualization system 100. The remote server cluster 140 may be located in distinct geographic locations or jurisdictions remote from the users. The remote server clusters 140 may include, among other components, web servers and service servers, as described below in detail with reference to FIG. 2. One of many functions of the remote server clusters 140 is to perform operations associated with managing, processing and storing the virtual desktops.

The application servers 150 execute, for example, the follow application programs: (i) the application programs that require a large amount of resources, (ii) the application programs that operate on a legacy software or hardware that is incompatible with those of servers in remote server clusters, or (iii) the application programs that are managed at a separate server for other business or technical reasons. Some application programs consume a significant amount of resources and may interfere with other operations of servers in the remote server clusters 140. Such application programs may include Quickview and Java Mail Client (JMC), both available from ZeroDesktop, Inc. of San Francisco, Calif. Quickview application generates image versions of documents in various formats to allow the users to conveniently view these documents without launching applications associated with these documents. The conversion of documents into the images involves a considerable amount of processing. JMC is a program that integrates with email servers to receive, compose, reply, forward and manage emails. JMC program may take up a considerable amount of communication bandwidth. Hence, it is advantageous to execute such application programs on a separate application server 150. Some applications from certain application programs operate on a server with certain software components and hardware configuration. For such application, it is advantageous to deploy a separate application for running the application programs. For example, to execute WINDOWS OFFICE suite (available from Microsoft, Inc. of Redmond, Wash.), WINDOWS® Terminal Services (also available from Microsoft, Inc. of Redmond, Wash.) must be installed on the server. Hence, it is advantageous to load and operate such application programs on a separate application server 150 adapted for the application programs. Finally, certain application programs require a separate license to operate on difference servers. In such cases, it is advantageous to operate these application programs on a dedicated server to reduce the license fees.

The authentication server 160 performs operations associated with user account management and/or load balancing across the remote server clusters 140. The user account management operations may include, for example: creating, updating or deleting user profiles stored in its internal memory or the database server 180; authenticating the users based on accessed user profiles; and approving access of the users to certain application programs. The authentication server 160 may also perform load balancing by determining the load conditions of individual or collective load of servers in the remote server clusters 140, and distribute user requests to multiple remote server clusters 140 depending on the load conditions. The authentication server 160 and the database server 180 may communicate data associated with the user account via the network 110 or a physical or logical channel 184 dedicated to communication between the authentication server 160 and the database server 180.

The file storage server 170 stores various files associated with the desktop virtualization. The stored files may include any files uploaded or generated by the users and temporary files generated by the desktop virtualization system 100 during operations associated with virtualization sessions. The remote server clusters 140 and the application servers 150 may access the files stored in the file storage server 170 to perform various operations. In one embodiment, the file storage server 170 is combined with the database server 180.

The files may be communicated to and from the file storage server 170 via the network 110 or a physical or logical channel 172 dedicated to communicating the files. Although FIG. 1 illustrates only a single file storage server 170, two or more file storage servers 170 may be deployed at the same or different geographical locations.

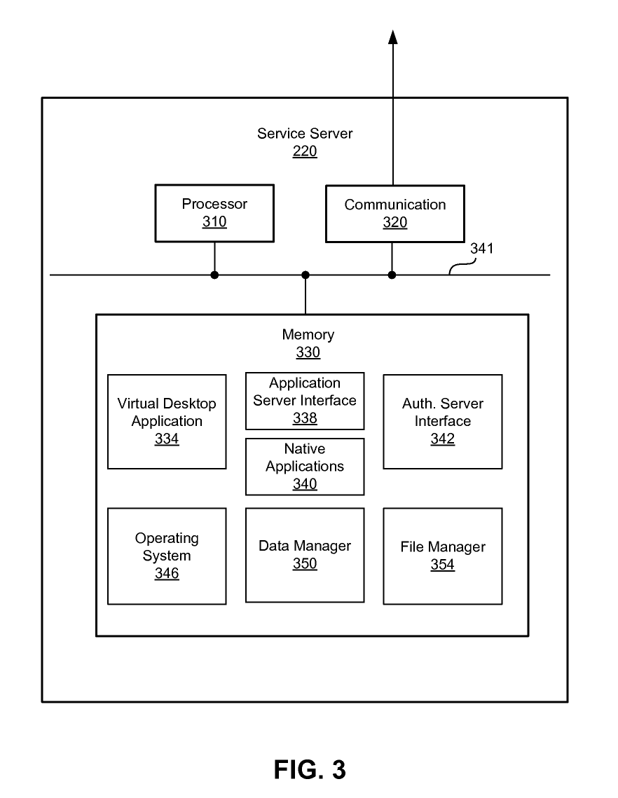

The database server 180 may store data entries associated with, for example, the user profiles, desktop profiles and metadata of the files. The user profiles include information about the user, as described below in detail with reference to FIG. 3. The desktop profile includes information about properties and characteristics of a virtualized desktop for a user, as described below in detail in a subsequent section titled “Desktop Profile.” The metadata in the database server 180 represent information about files stored in the file storage server 170, as described below in detail with reference to FIG. 3. In one embodiment, the database server 180 is embodied as a server running MySQL available from Sun Microsystems of Santa Clara, Calif.

The data to or from the database server 180 may be communicated to or from the database server 180 via the network 110 or a physical or logical channel 182 dedicated to communicating the user profiles or file metadata. Although FIG. 1 illustrates only one database server 180, two or more database servers 180 may be deployed at the same or different geographical locations.

Although the architecture of the virtual desktop system 110 in FIG. 1 distributes various functionalities across different servers in cloud computing environment, these functionalities may be provided by one or more servers co-located in the same premise. Some companies may prefer to have exclusive access to the servers for security or performance reasons. In such cases, a small number of servers located at the same premise may embody the functionalities of the authentication server 160, the remote server clusters 140, the file storage server 170, the application servers 150, and the database server 180. Alternatively, a hybrid model may be employed to assign part of functionalities to one or more servers privately controlled by the companies while assigning other functionalities to public servers.

### Architecture and Functions of Remote Server Cluster

FIG. 2 is a schematic block diagram of the remote server cluster 140, according to one embodiment. The remote server cluster 140 may include, among other components, one or more web servers 210 and one or more service servers 220. The web server 210 communicates with the service server 220 to transmit data for virtualized desktop to the user terminals 130 over the network 110, and passes information about user input activities at the user terminals 130 to the service server 220. Although FIG. 2 illustrates the web servers 210 and the service servers 220 as being embodied on separate servers, the web servers 210 and the service servers 220 may also be embodied in a single physical server. Alternatively, the web server 210 and the service server 220 may be located remotely from each other and communicate over the network 110 or other communication channels.

The web server 210 communicates data objects generated at the service server 220 to the user terminals 130 over the network 110. Various protocols may be used to communication data between the user terminals 130 and the web server 210. In one embodiment, the web server 210 uses web-based protocols such as HTTP (Hypertext Transfer Protocol) or its variant (e.g., HTTPS) to communicate with the user terminals 130. Compared to transmitting the pixel-level data over protocols such as RDP (Remote Desktop Protocol) or ICA (Independent Computing Architecture), using the web-based protocols has the following advantages: (i) the web-based protocols enable the web server 210 to communicate data associated with virtual desktops in a bandwidth-efficient manner, (ii) the web-based protocols eliminate or reduce software components that needs to be installed on the user terminals 130, (iii) the web-based protocols enable virtual desktop operations to be performed in a manner that is agnostic to operating systems, (iv) the web-based protocols facilitates development of applications compatible with the virtualization environment, (v) technology related to the web-based protocols are actively being enhanced, and hence, the web-based protocols can leverage various developments in related technology, and (vi) web-based protocols allow graphical user interfaces to be rendered and presented on the user terminals 130 in an efficient manner.

The web server 210 may include, among other components, a processor, a computer-readable storage medium (e.g., RAM (Random Access Memory)) and a communication interface (e.g., network card). The computer-readable storage medium stores computer instructions associated with Web server applications such as IBM WebSphere and Apache Web server that are executed by the processor. The web server 210 may also run middle layer applications to interface with the service server 220 and the user terminals 130.

The service server 220 generates data objects related to virtual desktops for transmission to the user terminals 130 via the web server 210. The service server 220 also received information about user input activities (e.g., clicks of mouse or typing of a keyboard) from the user terminals 130 via the web server 210. Based upon the user input activities, the service server 220 performs various operations associated with the virtual desktop such as moving the location of icons, opening of files, and launching of an application. To perform its operation, the service server 220 may communicate with the application servers 150, the file storage server 170 and the database server 180.

FIG. 3 is a block diagram illustrating the service server 220, according to one embodiment. The service server 220 may include, among other components, a processor 310, a communication module 320, a memory 330 and a bus 341 connecting these components. The processor 310 reads instructions and data from the memory 330 and performs operations. The communication module 320 is hardware, software, firmware or any combinations thereof for communicating with other components of the desktop virtualization system 100. The service server 220 illustrated in FIG. 3 is merely illustrative. Various other hardware, software or firmware may be provided on the service server 220 to perform additional functions or enhance performance.

The memory 330 is a computer-readable storage medium that stores instruction modules such as a virtual desktop application 334, an application server interface 338, one or more native applications 340, an authentication server interface 342, an operating system 346, a data manager 350 and a file manager 354. Two or more of these instruction modules may be combined into a single instruction module. Alternatively, one or more of these instructions modules may be divided into smaller instruction modules. Further, some of the instruction modules in FIG. 3 may be stored and executed on other components of the desktop virtualization system 100.

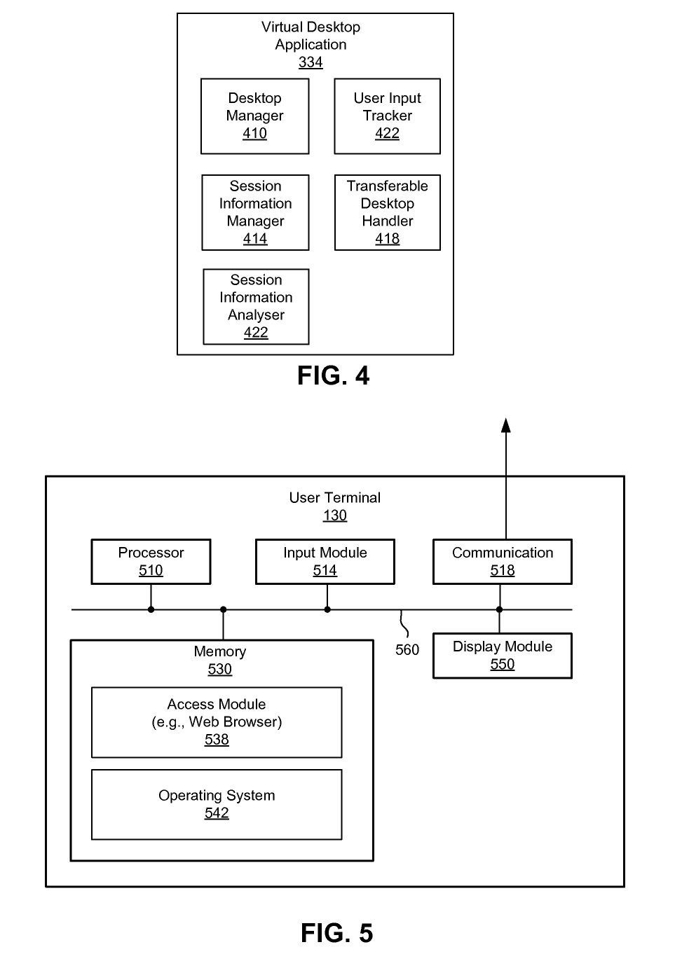

As described below in detail with reference to FIG. 4, the virtual desktop application 334 generates and sends data objects associated with virtual desktops to present graphical representations of the virtual desktops on the user terminals 130 as well as track and detect user input activities on the user terminals 130.

The application server interface 338 operates in conjunction with the virtual desktop application 334 to interface with the application servers 150. If the virtual desktop application 334 determines that a task requires assistance of the applications servers 150, the virtual desktop application 334 issues a command instructing the application server interface 338 to collect and send information for initiating operations on the application servers 150. The application server interface 338 may also receive the result of the operations from the application server 150 and forward the result to the virtual desktop application 334. The virtual desktop application 334 then generates data objects based on the result and sends the data objects to the user terminals 130 for presentation to the users.

Alternatively, the application server interface 338 may hand over the control of user interaction to the application server 150 when needed so that the application server 150 communicates directly with the user terminals 130. After the operations on the application server 150 is terminated, the application server interface 338 indicates to the virtual desktop application 334 that the virtual desktop application 334 should resume communication with the user terminals 130. In response, the virtual desktop application 334 resumes the control of user interaction.

The process of sending the requests to the application servers 150 and receiving the requests via the application server interface 338 may be performed in a manner that is transparent to the users. From the perspective of the users, operations on the virtual desktops appear as being operated on a single server. In one embodiment, the application server interface 338 communicates with the application servers 150 using, for example, HTTP, HTTPS, RDP (Remote Desktop Protocol) and ICA (Independent Computing Architecture).

The native applications 340 are applications designed to operate and launch in the virtual desktop environment. The native applications 340 may include, for example, text editors, media players, messengers, and file upload/download programs. These native applications 340 typically do not require a large amount of resources, and can be launched and executed on the application 334 without significantly affecting other operations associated with the virtual desktop. In one embodiment, the native applications interface with ZeroDesktop API (Application Programming Interface) available from ZeroDesktop, Inc. of San Francisco, Calif. to interact with the users.

The authentication server interface 342 communicates with the authentication server 160 to receive information about an authenticated user to grant access to the virtual desktop services. In one embodiment, the information about the authenticated user is a pointer to a user profile in the database server 180.

In one embodiment, the authentication server interface 342 tracks the load condition at the service server 220. The load condition may indicate, for example, the average percentage of processing capacity or memory capacity being used for a predetermined amount of time. The authentication server interface 342 sends information about the load conditions to the authentication server 160. Based on the load conditions, the authentication server 160 may determine which service server 220 to handle subsequently received user requests.

The operating system 346 manages resources of the service server. The operating system 346 may include, for example, Windows Server, Linux, OSX, Solaris 10, Netware, IRIX, and AIX. In one embodiment, the virtual desktop application 334 does not use a hypervisor to provide the desktop virtualization services. Instead, the virtual desktop application 334 uses virtual desktop profiles and web-based protocols to embody virtual desktops, as described below in detail with reference to FIG. 4. By obviating a hypervisor to manage multiple images of operating systems, the performance and scalability of the virtual desktop deployment are increased.

The data manager 350 communicates with the database server 180 to access database entries associated with, among others, the user profiles, the desktop profiles and the file metadata. The user profile may include, for example, the following fields: User ID, user password, user's nickname, user's email address, user's role (e.g., administrator or non-administrator), identification of the organization associated with the user, user's resident address, maximum resources (e.g., communication bandwidth or maximum data storage in the database server 180), previous log-in time or log-out times, whether the user is a paying or free subscriber, and user's ID on social networking services (e.g., Twitter or Facebook). The user profile may be associated with application permission information indicating applications that the user is permitted to access. During logging-in process, the authentication server interface 342 sends the information received from the authentication server 160 to virtual desktop application 334 to instantiate the virtual desktop for the user.

The file metadata includes information about a file associated with a user, and may include some or all of the following fields: the name of the file; the user associated with the file; the size of the file; the extension of the file; whether the file indicates a directory or not; whether the file is shared across all or a subset of users; when the file was created, accessed or modified; whether the file counts towards a storage quota assigned to the user; whether the file is encrypted; and a path on the file storage server 170 where the file is stored.

Many advantages of managing the file metadata on the database server 180 separate from the file storage server 170 are as follows: (i) various operations associated with files that do not require actual access to the files can be performed more efficiently and promptly, (ii) the overall size of the data in the database server 180 can be reduced to provide faster overall performance and facilitate various management operations, (iii) statistical analysis for various purposes can be performed more efficiently, and (iv) reduces risks associated with corruption in data entries of the database server 180.

Alternatively, the files can be stored in the database server 180 as blobs instead of being storing in a separate file storage server 170.

### Desktop Profile

Virtualizing a desktop by managing an image of a user's entire software (including the operating system) installed on a desktop may be resource intensive. Hence, instead of creating and managing separate software images for users, embodiments store information about a user's virtualized desktop in a compact desktop profile and user files. The graphical representation of the virtual desktop is generated on the user terminal 130 based on the desktop profiles and the user files. In this way, embodiments achieve virtualization of desktops for multiple users without maintaining the software image of a desktop computer and also without running a resource-intensive hypervisor on the service server 220. As a result, a virtualized desktop account can be set up for a user with only incremental increase in storage requirement.

For example, the additional memory required for an additional user may be as low as 368 Kbytes whereas additional storage space of as much as 5 Gigabytes is required to establish a virtual desktop account in other conventional desktop virtualization systems.

The desktop profiles are stored in the database server 180 and retrieved by the data manager 350. Based on the retrieved desktop profiles, the virtual desktop application 334 instantiates a virtual desktop after receiving a user's request. A desktop profile includes, among other information, the following: (i) information associated with graphical user elements (e.g., icons) to be displayed at the user terminal 130 of the user, such as the identification of the graphical user elements (e.g., an icon representing a document) and their coordinates on a screen or window of the user terminal 130, (ii) user preferences associated with the presented desktop (e.g., background color or image of the virtual desktop screen), (iii) information about association of file types with application programs, (iv) the user's language (e.g., English, Chinese), and (v) application permissions for controlling availability of application to the user.

Example information about the association of file types for a BMP image file, as stored in the desktop profile, is listed in following Table 1.

TABLE 1

| Field | Data type | Examples |
|---|---|---|
| filetype_extension | character | Bmp |
| filetype_description | character | BMP Image |
| filetype_icon | character | file_picture.gif |
| Application | character | com_zerodesktop_app_PictureViewer |

Table 1 indicates that the virtual desktop application 334 associates any files with extension of “.bmp” with a BMP image (filetype_description). For files with “.bmp” extension, the virtual desktop application 334 represents this file on a virtual desktop using an icon named “file_picture.gif.” Further, when the user attempts to open files with “.bmp” extension (e.g., by double clicking the icon on the user terminal 130), the virtual desktop application 334 launches application “com_zerodesktop_app_PictureViewer” and loads the double-clicked file onto the launched application. Separate tables may be generated and managed for each type of files.

In one embodiment, when a user first logs-on to the remote server cluster 140, the user is presented with a graphical user interface screen similar to a desktop window on an operating system such as WINDOWS series operating system (available from Microsoft Corporation of Redmond, Wash.) and OS X operating system (available from Apple Inc. of Cupertino, Calif.) based on the desktop profile. If the user changes the locations of icons, generates or uploads files or changes default applications for launching certain types of files, the desktop profile of the user is updated accordingly and stored in the database server 180 after the user logs off. Hence, when the same user later logs-on, the user is presented with the same graphical user interface screen that was presented to the user before the user logged-off.

### Virtual Desktop Presentation and Interfacing

FIG. 4 is a block diagram illustrating the virtual desktop application 334, according to one embodiment. The virtual desktop application 334 may include, among other components, a desktop manager 410, a user input tracker 422, a session information manager 414, a transferable desktop handler 418 and a session information analyzer 422. The virtual desktop application 334 may also include other components for providing additional services to the user.

The desktop manager 410 performs, among other functions, the function of generating data objects and sending the data objects to the user terminal 130 for presentation to the user. When a HTTP request is received from the user terminal 130 via the web server 210, the desktop manager 410 accesses a library to assemble data objects and encode the data objects for transmittal to the user terminal 130. The data objects for transmittal include, for example, window objects, menu objects, theme objects and user session objects, which are processed by the user terminal 130 to render windows, menu items, textual data and other desktop images. In one embodiment, these objects are encoded and packaged as JSON (JavaScript Object Notation) objects. The desktop manager 410 then sends the JSON objects via the web server 210 as a HTTP response.

The following is an example pseudo-code of JSON objects:

{result:[
{“isdir”:true,“ts”:1280241204000,“isencrypted”:0,“pid”:
“m”,“date”:“Tuesday, July 27, 2010
2:33PM”,“size”:0,“id”:“m275328”,“isshared”:false,“owner
name”:“userXYZ”,“name”:“MyMovies”,“owner”:2892,“path”:“
”},
{“isdir”:true,“ts”:1280241203000,“isencrypted”:0,“pid”:
“m”,“date”:“Tuesday, July 27, 2010
2:33PM”,“size”:0,“id”:“m275299”,“isshared”:false,“owner
name”:“userXYZ”,“name”:“Desktop”,“owner”:2892,“path”:“”
}
]}

The above pseudo-code is included in a HTTP response from the virtual desktop application 334 generated in response to receiving a HTTP request from the user to open a native application for viewing and navigating through folders and files associated with the virtual desktop. The above pseudo-code includes two JSON objects, one indicating “MyMovies” folder, and another indicating “Desktop” folder. The entire JSON object is delimited by the curly braces (“{”, “}”), and each of the JSON objects is formatted in a name-value pair delimited by curly braces (“{”, “}”). “isdir” field may take a true or false value and indicates whether the data object is associated with a folder or file. “ts” field relates to time stamp indicating the time that the JSON objects were generated, “isencrypted” field takes a true or false value and indicates whether the folder or file is encrypted or not. “pid” field represents a parent entity (e.g., folder) of the JSON object to implement hierarchy of data objects. “date” field indicates the date that the JSON object was originally created. “isshared” field takes a true or false value and indicates whether the folder is shared with other users. “owner name” indicates the user associated with the file (here, the use is “userXYZ”). “name” field indicates the name of the JSON object. “owner” field is followed by a unique number identifying the user. Finally, “path” field indicates the logical path of the file or folder in the virtual desktop (here, both folders are located at root).

The user input tracker 422 operates to receive event information from the user terminal 130 such as clicking of mouse buttons on an icon and typing on a keyboard. The event information may be encoded into JSON objects and then packaged into a HTTP request at the user terminal 130.

When the HTTP request from the user terminal 130 invokes operations on the application server 150, the desktop manager 410 sends a JSON object to the user terminal 130 to reserve resources on the user terminal 130 (e.g., an area on the screen of the user terminal 130) for interacting with the application server 150. The application server interface 338 (see FIG. 3) sends data necessary for performing the requested operation to the application server 150. The application server 150 then takes over the processing for the reserved area on the screen, and interacts with the user terminal 130 directly to send information and receive user input. The application server 150 may then access the file storage server 170 and the database server 180 to create, load, store, modify or delete files. If the HTTP request involves loading of a file onto the application server 150, the application server interface 338 retrieves the metadata of the file and sends the metadata to the application server 150. The applications server 150 may then load the file corresponding to the metadata for operation.

The session information manager 414 manages a virtual desktop session with a user by creating and updating session information for each session. The session information is stored in the file storage server 170 and may be accessed to restart a virtual desktop session. The session information may include, for example, the following: (i) IP address of the user terminal 130, (ii) information about programs being used, (iii) the user profile, (iv) web browser of the client terminal 130, (v) currently connected application server 150 or servers in remote server cluster 140, (vi) authentication token, (vii) statistical information such as login time and session length, (viii) data objects (e.g., files or advertisements) being accessed by a users while accessing a virtual desktop. If a service server 220 handling a user's request becomes inoperable, the session information may be retrieved by another service server 220 to resume the session with the user.

The transferable desktop handler 418 performs handling of transferable virtual desktops, as described below in detail in a section entitled “Transferable Virtual Desktop.”

The session information analyzer 422 analyzes the session information of one or more sessions to extract useful information. The session information analyser 422 may employ various statistics tool to extract information related to, for example, which data objects are often accessed by users, different duration of time that users accessed the data objects, access patterns depending on user profiles, geographic locations of users and application usage patterns of users.

FIG. 5 is a block diagram of the user terminal 130, according to one embodiment. The user terminal 130 may include, among other components, a processor 510, an input module 514, a communication module 518, a memory 530, a display module 550, and a bus connecting these components. The user terminal 130 may include components such as a speaker not illustrated in FIG. 5. The processor 510 executes computer instructions stored in the memory 530 to perform various operations. The input module 514 is hardware, software, firmware or a combination thereof for receiving user input. The input module 514 may include, for example, one or more of mouse, keyboard, keypad, touchscreen and remote controller. The communication module 518 is hardware, software, firmware or a combination thereof for communicating with other components of the desktop virtualization system 100 via the network 110. The display module 550 is hardware, software, firmware or a combination thereof for displaying graphical user interface elements. The display module 550 may include, for example, a graphics processing unit, a display driver and a display screen.

The memory 530 stores software components for operating the user terminal 130. The software components in the memory 530 may include, among other components, an operating system 542 for managing and allocating resources of the user terminal 130 to various operations, and an access module 538 for accessing the virtual desktop instantiated on the service server 220. The memory 530 may store various other software components that are omitted herein for the sake of brevity.

The access module 538 may be embodied as any software for navigating and accessing web-based information from a web server over the network 110. In one embodiment, the access module 538 is embodied as a web browser capable of sending HTTP requests to web servers and receiving HTTP responses from the web servers. Example web browsers include Internet Explorer (IE) (available from Microsoft of Redmond, Wash.), Safari (available from Apple Inc. of Cupertino, Calif.), Mozilla Firefox (available from Mozilla Corporation of Mountain View, Calif.) and Chrome (available from Google Inc. of Mountain View, Calif.). After a user requests a virtual desktop session, the HTTP request is sent to the authentication server 160. The user provides user ID and password (or other authentication information) that is sent to the authentication server 160. If the user is successfully authenticated, then the authentication server 160 forwards the HTTP request to the remote server cluster 140.

The access module 538 renders the graphical representation of the virtual desktop by interpreting, for example, a combination of HTML, CSS, JavaScript, images and other related web technology components. In one embodiment, the access module 538 includes a Javascript/Ajax library for handling JSON objects. In response to the HTTP request, the access module 538 receives JSON objects from the remote server cluster 140. The access module 538 parses the received JSON objects, extracts data from the JSON objects, and renders a graphical user interface screen based on the extracted data. Most web browsers are capable of operating with Javascript/Ajax library, and hence, these web browsers can function as the access module 538 without installation of additional software components or with the installation of a small-sized library. Further, similar operations associated with virtualization can be expected from different web browsers because Javascript/Ajax library is accessed and used consistently throughout different web browsers. In one embodiment, Javascript/Ajax library is ZeroDesktop Javascript Application Framework available from ZeroDesktop, Inc. of San Francisco, Calif.

After an initial virtual desktop screen is presented on the screen of the user terminal 130, the user may perform operations such as launching an application or opening a file. In response to receiving user input for such actions at the input module 514, the access module 538 creates JSON objects based on the Javascript/Ajax library, and sends the created JSON objects to the remote server cluster 140 in a HTTP request. The remote server cluster 140 then performs operations based on the received JSON objects and returns another set of JSON objects for generating an updated graphical user interface screen on the user terminal 130. The access module 538 and the remote server cluster 140 exchange the JSON objects in the form of HTTP requests and HTTP responses to perform operations associated with the virtual desktop.

By communicating high-level JSON objects instead of low-level pixel data, the desktop virtualization system 100 can significantly reduce the bandwidth needed for performing virtual desktop operations. Moreover, the virtual desktop operations may be performed using various web browsers with minimal or no additional software installation.

### Transferable Virtual Desktop

Transferable virtual desktops may be created, used, modified and deleted or stored by any registered user. Multiple transferable virtual desktop instances are replicated to have the same configuration and properties. The transferable virtual desktop enables multiple users to share the same experience and assist any collaborative tasks. If a user decides to store an instance of the transferable virtual desktop, a profile of the transferable virtual desktop is generated and stored for later access. The transferable virtual desktops may be used, for example, in publishing media contents to subscribers.

To facilitate the creation of transferable virtual desktops, a transferable desktop template may be created and provided for the creator of the transferable virtual desktops. The creator may modify, add or delete items (e.g., files or icons) or change characteristics of the transferable desktop template, and thereby create a customized transferable virtual desktop. In one embodiment, the transferable desktop template is created by an administrator of the virtualized desktop system 100. The transferable desktop template may also define certain properties and characteristics of the transferable virtual desktops to be created based on the transferable desktop template.

The properties and characteristics of the transferable desktops may also be set independent of the transferable desktop template. Such properties and characteristics of the transferable virtual desktops include, for example, the following: (i) whether the transferable virtual desktop instance can be stored as a user's desktop, (ii) the common name of the transferable desktop, and (iii) various restrictions associated with the instantiation of the transferable desktops. The restrictions may include, for example, (i) the number of total transferable desktops that can be instantiated, (ii) the number of transferable desktops that can be concurrently instantiated, (iii) the number of users' desktop profiles that can be derived from the transferable desktop profile and stored in the database server 180, (iii) the permissible time during which the transferable desktop can be instantiated or replicated, (iv) the geographic region of the user that can access the transferable desktops. Such restriction may assist conservation of resources in the desktop virtualization system 100 as well as enforcement of digital rights management (DRM).

When a user requests access to a transferable virtual desktop, temporary user ID may be created for the user requesting the access. For temporary user ID, the process of receiving and processing information for opening a regular user account can be omitted, which facilitates the use and access to the transferable virtual desktop instance. The temporary user ID may be deleted after an event is detected. The event may include, for example, (i) termination of a session associated with the transferable virtual desktop instance, (ii) expiration of a predetermined amount of time set by the creator or the administrator, and (ii) receiving of a command from the creator or the administrator.

Alternatively, a user with account established in desktop virtualization system 100 may request a copy of transferable virtual desktop instance be associated with the user's account instead of using a temporary user ID. After performing operations on the transferable virtual desktop instance, the user may request the transferable virtual desktop instance be stored as a version of the user's virtual desktop. When the user request storing of the transferable virtual desktop instance as the user's virtual desktop, a desktop profile for the transferable virtual desktop instance is generated and stored in the database server 180. Each user with an account can store multiple instances of transferable virtual desktops as versions of the user's virtual desktop and choose to perform operations based on an instance of the user's virtual desktops. In such case, multiple desktop profiles are stored in the database server 180 for the user.

In one embodiment, after a transferable virtual desktop instance is created, the transferable desktop handler 418 of the virtual desktop application 334 stores the desktop profile of the transferable virtual desktop instance in the database server 180, indexed by a transferable virtual desktop identification. When a user requests instantiation of a transferable virtual desktop, the transferable desktop handler 418 identifies the desktop profile corresponding to the request, retrieves the desktop profile, copies the desktop profile (and other associated files, if any), and assigns the copied version of the desktop profile (and other copied files, if any) to the user or users with accounts in desktop virtualization system 100.

The transferable desktop handler 418 then passes information about the copied desktop profile (and other files, if any) to the desktop manager 410. The desktop manager 410 then operates to present a virtualized desktop based on the copied desktop profile (and copied files, if any) to the user, as described above in the section entitled “Virtual Desktop Presentation and Interfacing.” After the virtualization session with the user is terminated, the desktop manager 410 passes information about the results of the virtualization session to the transferable desktop handler 418. The results of the session may include, for example, a transferable desktop profile and files as changed or added by the user.

The transferable desktop handler 418 may then process the transferable desktop profile or files as configured. The transferable desktop handler 418 performs, for example, the following operations after the session is terminated: (i) delete the entire transferable desktop profile or associated files, (ii) extract certain files, store these files for access by creators or other entities, and delete the transferable desktop profile and other files, (iii) load a subsequent transferable desktop profile for presentation to the user or (iv) generate and store a user desktop profile that is a replicated version of the transferable desktop profile.

An example use case of the transferable virtual desktop involves deployment in educational environment. Conventionally, a teacher preparing a lecture or class has to prepare relevant materials and distribute the materials to students before or during the lecture or class. Copying and distributing the materials, however, takes a significant amount of time and efforts on the part of the teacher. Even if the students are provided with a separate personal computer, the teacher may have to spend a large portion of the classroom time sending the materials or telling the students where the materials can be accessed. If the students are young or unfamiliar with the use of computers, this issue may be exacerbated.

In the use case, the teacher prepares a transferable virtual desktop based on the template assigned to the teacher. The transferable virtual desktop may include movies, articles and a quiz document, relevant to the subject that the teacher will be covering during an in-class session. After the class starts, the teacher hands out the URL where the student may access the classroom materials. The students type in the URL at a web browser launched on the student's computer, and the students are given instant access to the copies, or instance, of the transferable virtual desktop.

During the session, the students may access movies and read articles by simply clicking corresponding icons displayed on the web browser. The students may make changes to files, generate or update documents, and launch applications. The transferable virtual desktop instance presented to each student is a distinct copy separate from other transferable virtual desktop instances, and hence, any modification or operation on one transferable virtual desktop instance for a student does not affect other transferable virtual desktop instances assigned to other students.

The students may be asked to answer questions in the quiz document by typing in the answers in the same quiz document. The quiz document updated with the answers is stored in the file storage server 170.

After the session is finished, the students close the web browsers and end the virtualization session. The transferable desktop handler 418 may collect the quiz documents as updated by the students but may delete other information associated with the transferable virtual desktop instances. The quiz documents may be sent to the student for evaluation by the teacher.

Another example use case involves temporary use of a public user terminal. For example, a government office (e.g., unemployment office) may require individuals to complete an application for certain benefits. A transferable desktop template may be defined to include a blank application in a transferable virtual desktop. When an individual sits down at a terminal, the individual may invoke the transferable desktop instance and be presented with the blank application. The individual can fill out the application with personal and confidential information, and then print the application or electronically transmit the application to a receiver. After the transferable virtual desktop instance is closed that confidential and personal information is automatically deleted.

By removing other information, the resources of the server servers 220, the files storage server 170 and the database server 180 may be made available for other operations.

Still another example use case involves use of transferable virtual desktop for various publishing purposes. A creator may create newsletters, newspapers, magazines and other periodicals in the form of transferable virtual desktop. Non-periodicals such as e-books may also be created using the transferable virtual desktops. Various articles, multimedia files and other information may be organized in the form of transferable virtual desktop. Instead of being limited to static contents (as in paper periodicals), the creator can configure the transferable virtual desktop to provide rich and enhanced experience to the users in an organized manner.

The periodicals may be published by sending an address for accessing the transferable virtual desktop in the form of bulk messages to a large number of users. The users may in turn send out the address to other users, enabling viral propagation of the transferable virtual desktop.

Using transferable virtual desktop to publish various information is advantageous, among other reasons, because (i) users can experience rich and enhanced multimedia experience compared to other forms of media, (ii) information of users' access can be collected at lower granularity compared to other conventional forms of media, and (iii) the publication can be performed in a cost-effective and efficient manner compared to other conventional forms of media.

### Example Method of Creating and Using Transferable Virtual Desktop

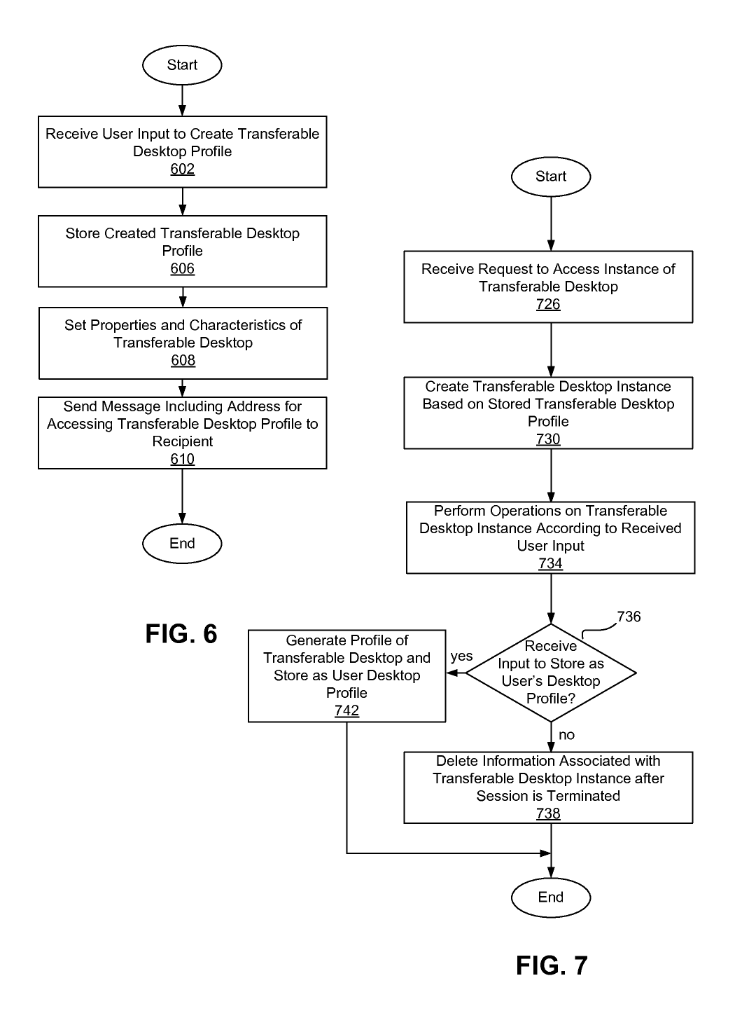

FIG. 6 is a flowchart illustrating a method of creating, storing and sharing a transferable virtual desktop by a creator, according to one embodiment. The remote server clusters 140 receives 602 user input from an administrator or a creator to create a transferable desktop. The user input may include, for example, moving graphical user elements (e.g., icons), uploading of files, and changing the background image of the transferable virtual desktop. In one embodiment, the transferable desktop profile is created based on a template associated with the administrator or the creator, as described in U.S. patent application Ser. No. 12/881,079, which is incorporated by reference herein in its entirety.

After the creator finalizes the transferable virtual desktop, a transferable desktop profile (and associated files, if any) corresponding to the transferable virtual desktop is stored 606 in the file storage server 170 or the database server 180. In one embodiment, the transferable virtual desktop is assigned a URL (universal resource locator). An example URL may be “http://www.zerodesktop.com/os/?mode=4thgradescience.”

The creator may also set 608 the properties and characteristics of transferable desktop such as (i) whether the transferable virtual desktop can be stored as a user's desktop and (ii) the common name of the transferable desktop, and (iii) various restrictions associated with the instantiation of the transferable desktops.

An administrator, a creator or a user sends 610 messages including address (e.g., URL) of the transferable desktop profile to other users. The address may be provided in the form of a hyperlink embedded in an email or a webpage. Using the address, the other users can request the remote server cluster 140 to instantiate transferable desktops according to the stored transferable desktop profile.

Alternatively, the messages may merely notify that a transferable desktop profile has been created or updated. The notification messages may indicate that a transferable desktop profile associated with a group are created or updated. The group may be identified, for example, by a uniquely assigned group ID. When the users receive the notification messages, the users may access the transferable desktop profile by logging into the remote server cluster 140 and entering the group ID. The use of group ID facilitates recognition and management of group activities by the users.

FIG. 7 is a flowchart illustrating a method of accessing and operating a transferable desktop instance, according to one embodiment. After a user obtains the address to a transferable virtual desktop profile, the user sends a request to access an instance of the transferable virtual desktop to remote server cluster 140. In one embodiment, the request is a HTTP request to load a webpage corresponding to the URL assigned to the transferable virtual desktop (e.g., http://stage.zerodesktop.com/os/?mode=4thgradescience). In one embodiment, the virtual desktop application 334 determines whether the request is for a transferable virtual desktop by detecting the presence of a string of characters (e.g., “?mode=”) in the URL.

In one embodiment, after the virtual desktop application 334 receives 726 the request for a transferable virtual desktop, the virtual desktop application 334 creates a temporary user profile for the user. For a temporary user, the transferable virtual desktop is used temporarily and then deleted. Hence, there is no reason to collect detailed information about the temporary user. In contrast, a user ID and authentication information (e.g., password) may be received for an account holder of the virtual desktop service. The user may associate the transferable virtual desktop with the user's account in desktop virtualization system 100.

Then the transferable desktop profile created by the creator is copied and assigned to the user subject to the restrictions associated with the transferable desktop (e.g., the maximum number of transferable desktop that can be instantiated concurrently). After the copy of the transferable desktop profile is assigned to the user, the virtual desktop application 334 sends data objects associated with the transferable desktop profile to start a virtual desktop session with the user. Any files associated with the transferable desktop profile may also be copied and assigned to the user. Based on the replicated transferable desktop profile and the copied files, the transferable desktop instance is created 730 for the user.

The user may perform 734 operations on the transferable desktop instance by providing user input actions (e.g., moving an icon and double-clicking an icon) on the user terminal 130. The data objects associated with the user input actions are generated and sent from the user terminal 130 to the virtual desktop application 334. The virtual desktop application 334 receives the data objects and extracts the user input from the data objects.

The virtual desktop application 334 then performs 734 operations according to the received user input activities. The operations may include, for example, launching an application program responsive to double-clicking of an icon associated with the application program or a file. The process of receiving user input and performing operations 734 may be repeated while the session is active.

Before terminating the session, it is determined 736 if a user input to store the transferable virtual desktop as a version of user's desktop profile is received from the user. If such user input is not received, information associated with the transferable desktop instance is deleted 738 after the session is terminated. In contrast, if a user input is received to store the transferable virtual desktop, the transferable desktop instance is processed into the user's desktop profile and stored 742 in the file storage server 170 or the database server 180 after the session is terminated. Then the process terminates.

The processes described above with reference to FIGS. 6 and 7 are merely illustrative. Various modifications can be made to the processes of FIGS. 6 and 7. For example, transferable desktop profiles may be generated without using the transferable desktop templates. The creator may use the creator's own desktop profile to create and store the transferable desktop template. Further, the process may include the step of confirming whether the number of users requesting the transferable virtual desktop does not exceed a predetermined number. If the number of users requesting the same transferable virtual desktop exceeds a threshold, the virtual desktop application 334 may decline to copy and assign any more transferable desktop profiles.

In one embodiment, at least part of the transferable desktop profile or associated files may be stored after use for account holders. The stored virtual desktops may then be submitted for review or later retrieval. In one embodiment, the template for creating the transferable virtual desktop includes information about whether the transferable virtual desktop created from the template can be stored after use.

Using the virtual desktop profiles to create and provide services for the transferable virtual desktops is advantageous because of the low resource requirements. Compared to conventional virtual desktop infrastructure (VDI) schemes where the remote server maintains entire copies of the software components in a desktop, embodiments using the virtual desktop profiles can provide copies of virtualized desktops in a prompt manner without exhausting the resources. In a conventional desktop virtualization scheme, at least few minutes may be needed to copy and load an image of virtual desktop in a remote server, hundreds of megabytes or gigabytes of memory space to add a single user and manual intervention of a system administrator. Hence, it is too costly in terms of cost and time to accommodate temporary users and transferable virtual desktops in conventional VID schemes. In contrast, the compact nature of virtual desktop profiles of embodiments allows prompt launching of temporary desktop profiles and servicing of virtual desktops to users.

### Online Propagation of Modified Virtual Desktop

In one embodiment, the transferable desktop profile is updated and propagated to copies of the transferable virtual desktops while the users are accessing and using the copies of the transferable virtual desktops. The transferable desktop handler 418 keeps track of the transferable virtual desktops generated from a transferable desktop profile. As the creator, the administrator or another party updates the transferable desktop profile while users are accessing the transferable virtual desktops, the changes to the transferable desktop profile are automatically propagated to the copied transferable virtual desktops. Hence, the users are automatically presented with an updated transferable desktop profile.

In one embodiment, the transferable desktop handler 418 may propagate the changes in the transferable virtual desktop upon detecting an event. Until the event is detected, any changes made to the transferable desktop profile do not take effect on the transferable virtual desktops that are already copied and accessed by the users. After the event is detected, the transferable desktop handler 418 determines the transferable virtual desktops copied from an unmodified desktop profile, and replaces the unmodified desktop profile with a modified desktop profile.

The event for propagating the changes may include, among others, commands from the creators of the transferable desktop profile, commands from the user or other parties, expiration of a predetermined amount of time, and detecting of other conditions (e.g., at least one transient achieving a goal). In one embodiment, the creator or administrator sets the conditions for propagating the changes to the transferable desktop profile to the students.

A use case for the online propagation of the transferable desktop profile is described herein. Taking the example use case of classroom education, a teacher creates a transferable desktop profile for a class. Students access transferable virtualized desktops instantiated by copying the transferable desktop profile. Instead of using multiple URL addresses to have the students access different transferable virtual desktops for each class, a single URL (e.g., http://www.zerodesktop.com/os/?mode=4thgradeclass) is used throughout multiple classes. As a new class starts, the teacher updates (or loads) the transferable desktop profile associated with the URL and sends a command to the transferable desktop handler 418 to propagate the updated transferable desktop profile.

The transferable desktop handler 418 then automatically propagates the changes to the transferable desktop profile by replacing the previous transferable desktop profile with the updated transferable desktop profile. A set of transferable virtual desktops are then instantiated based on the updated transferable desktop profile for the students. In this way, the students do not need to input separate URLs for different classes, and the teacher can have more control over which virtual desktops are presented to the students.

### Example Graphical User Interfaces

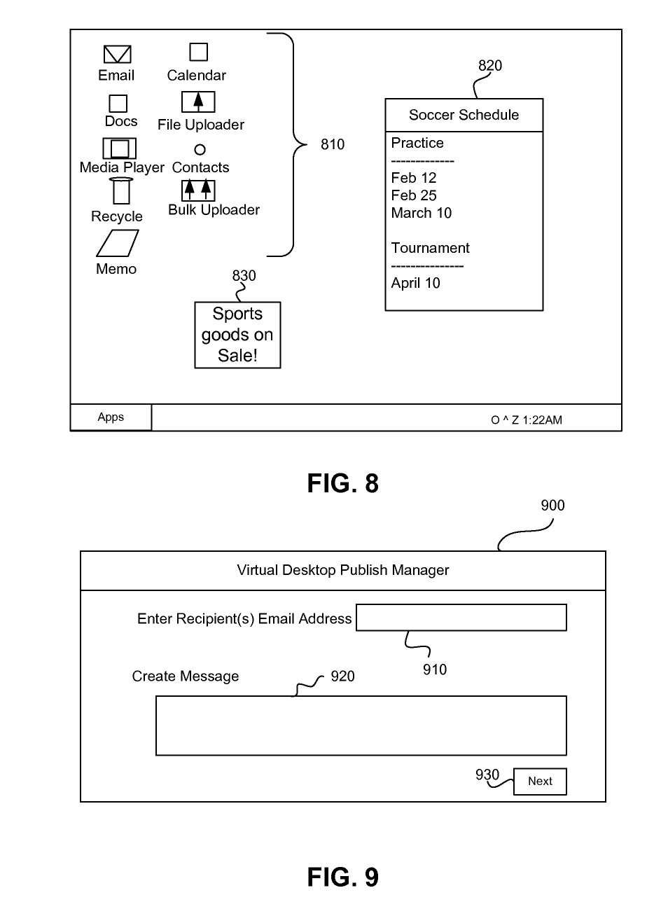

FIG. 8 is a graphical representation of a transferable desktop instance, according to one embodiment. The creator may modify the virtual desktop as illustrated in FIG. 8 by adding, removing files, changing the locations of icons and/or setting the background image of the desktop profile. After preparing the virtual desktop, the creator finalizes the transferable desktop profile and stores it in the database server 180. Icons 180 for prompting various operations on the virtual desktop are also illustrated in FIG. 8.

The transferable virtual desktop of FIG. 8 includes a memo 820 and an advertisement 830 that is presented to users accessing the transferable virtual desktop. In this example, the transferable virtual desktop is shared by members of a football club and conveys information related to football events. The advertisement 830 may be added in the transferable virtual desktop using the technique disclose, for example, in U.S. patent application Ser. No. 12/892,259, filed on Sep. 29, 2010, and titled “Virtual Desktop Service with Targeted Advertisement,” which is incorporated by reference herein in its entirety.

FIG. 9 is a graphical representation of a user interface 900 for sending address of a transferable template profile, according to one embodiment. The user interface 900 may be launched during or after creating a transferable desktop profile. The user interface 900 may also be launched when a user who received the address of a transferable desktop profile wishes to send the transferable desktop profile to other users. The creator or user may enter email addresses of other users to receive the address (e.g., URL) of the transferable desktop profile in text box 910.

To facilitate sending of emails to a large number of users, group emailing may be implemented. A group may be identified by a group ID and include email addresses for multiple users belonging to the group. The group ID may be identified in text box 910 instead of individual email addresses to facilitate sending of the addresses to a large number of recipients.

The creator or user may also add messages in text box 920 to draft a custom message to the recipients. After specifying the recipient's email address and message, the creator or user may click ‘next’ box 930 to finalize and send the address to other users.

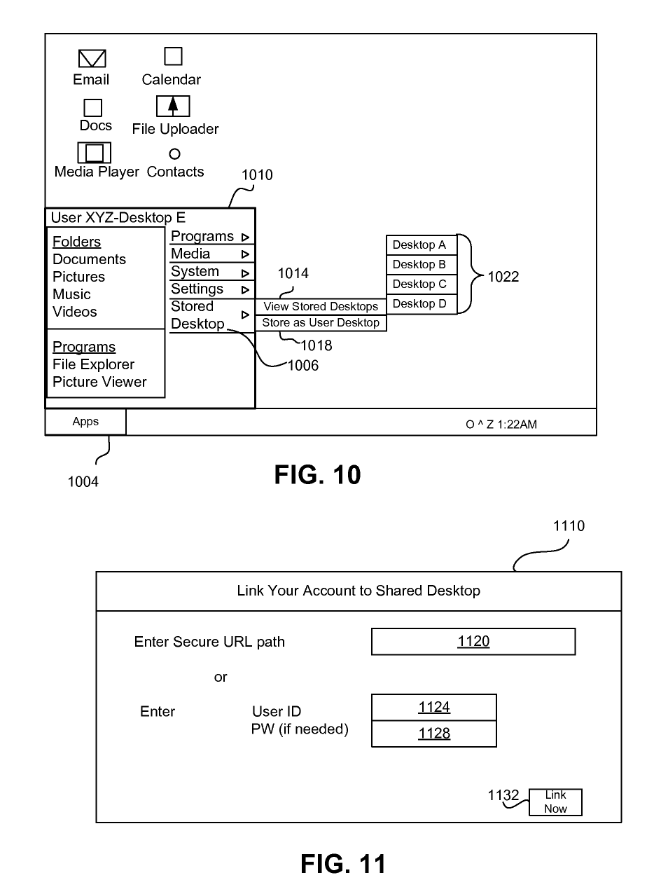

FIG. 10 is a graphical representation of a user interface for selecting a stored user desktop profile, according to one embodiment. When user XYZ clicks ‘apps’ icon 1004, menu 1010 is launched to present user XYZ with various options. One of the options relates to accessing stored virtual desktops. When the user clicks “Stored Desktop” region 1006, two additional options are presented. One option is viewing stored desktops and the other is linking and saving current virtual desktop instance as one of the user's virtual desktop.

In FIG. 10, the option of viewing stored desktops can be selected by choosing box 1014. As a result, desktops A through D are displayed in boxes 1022. If the user wants to launch a different virtual desktop (in FIG. 10, desktop E is currently launched), the user may select one of the desktops listed in box 1022. In one embodiment, at least some of the virtualized desktops presented for display are associated with a group ID identifying a group associated with the virtual desktop.

When a user accesses a transferable virtual desktop, the user may choose to store the transferable virtual desktop by clicking box 1018. In response to clicking box 1018, the user may be prompted to enter the user ID and password (if not already entered), and also name or identity under which the transferable virtual desktop should be stored. After the user ID, password and name/identity is entered, the transferable virtual desktop instance is converted into a user's desktop profile and stored for later access.

FIG. 11 is a graphical representation of a user interface for linking a user's account to a transferable desktop instance, according to one embodiment. Instead of linking and saving the profile from the instantiated virtual desktop, the user may instead opt to store the transferable desktop instance using the URL associated with the transferable desktop profile. The user may enter the URL of the transferable desktop profile in box 1120, enter user ID in box 1124 and enter password in box 1128. Then the user may click “link now” icon 1132 to convert and store the transferable desktop instance as the user's desktop profile.

### Alternative Embodiments

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A method of sharing virtualized computers by a plurality of users, comprising:
receiving data for setting a first computer profile of an original virtual computer from a first user at a computing device, the computer profile representing information about properties and characteristics of the original virtual computer;
creating a replicated virtual computer of the original virtual computer on the computing device by replicating the computer profile responsive to receiving a request from a second user to access the replicated virtual computer; and
performing operations associated with the replicated virtual computer on the computing device responsive to receiving a first input from the second user.

2. The method of claim 1, further comprising storing a second computer profile of the replicated virtual computer on the computing device responsive to receiving a second input from the second user.

3. The method of claim 1, further comprising transmitting an address for requesting creating of the replicated virtual computer to the second user.

4. The method of claim 1, wherein the request comprises a HTTP (Hypertext Transfer Protocol) request to access resources on the computing device.

5. The method of claim 3, wherein the address comprises a URL (Universal Resource Locator).

6. The method of claim 1, wherein a plurality of computer profiles associated with the second user are stored in the computing device.

7. The method of claim 6, further comprising instantiating another virtual computer on the computing device responsive to receiving third input selecting the other virtual computer.

8. The method of claim 1, wherein the computing device sends data for presenting the original virtual computer or the replicated virtual computer to a user terminal of the second user using HTTP (Hypertext Transfer Protocol) or its variant protocol.

9. The method of claim 8, wherein the computing device sends the data comprising JSON (JavaScript Object Notation) objects to the user terminal to present graphical user interfaces corresponding to the original virtual computer or the replicated virtual computer.

10. The method of claim 1, wherein the original virtual computer is part of a series of virtual computers published periodically.

11. The method of claim 1, wherein the original virtual computer comprises advertisements.

12. A computer system for sharing virtualized computers by a plurality of users, comprising:
a communication module configured to receive data for setting a first computer profile of an original virtual computer from a first user at a computing device, the computer profile representing information about properties and characteristics of the original virtual computer;
a virtual desktop application configured to receive the data from the communication module, the virtual desktop application further configured to:
create a replicated virtual computer of the original virtual computer on the computing device by replicating the computer profile responsive to receiving a request from a second user to access the replicated virtual computer; and
perform operations associated with the replicated virtual computer on the computing device responsive to receiving a first input from the second user.

13. The computer system of claim 12, wherein the virtual desktop application is further configured to store a second computer profile of the replicated virtual computer on the computing device responsive to receiving a second input from the second user.

14. The computer system of claim 12, wherein the virtual desktop application is further configured to transmit an address for requesting creating of the replicated virtual computer to the second user.

15. The computer system of claim 12, wherein the request comprises a HTTP (Hypertext Transfer Protocol) request to access resources on the computing device.

16. The computer system of claim 14, wherein the address comprises a URL (Universal Resource Locator).

17. The computer system of claim 12, wherein the virtual desktop application is further configured to store a plurality of computer profiles associated with the second user on the computing device.

18. The computer system of claim 17, wherein the virtual desktop application is further configured to instantiate another virtual computer on the computing device responsive to receiving third input selecting the other virtual computer.

19. The computer system of claim 12, wherein the virtual desktop application is configured to send data for presenting the original virtual computer or the replicated virtual computer to a user terminal of the second user using HTTP (Hypertext Transfer Protocol) or its variant protocol.

20. A computer-readable storage medium storing instructions thereon, the instructions when executed by a processor in a computing device, cause the processor to:
receive data for setting a first computer profile of an original virtual computer from a first user, the computer profile representing information about properties and characteristics of the original virtual computer;
create a replicated virtual computer of the original virtual computer on the computing device by replicating the computer profile responsive to receiving a request from a second user to access the replicated virtual computer; and
perform operations associated with the replicated virtual computer on the computing device responsive to receiving an input from the second user.
